(19) United States
(12) Patent Application Publication
(10) Pub. No.: US 2023/0030882 A1
(43) Pub. Date: Feb. 2, 2023

(54) INFORMATION PROCESSING DEVICE AND METHOD, PRINT SYSTEM, AND NON-TRANSITORY COMPUTER READABLE MEDIUM

(71) Applicant: FUJIFILM Business Innovation Corp., Tokyo (JP)

(72) Inventor: Hiroomi ICHIBA, Kanagawa (JP)

(73) Assignee: FUJIFILM Business Innovation Corp., Tokyo (JP)

(21) Appl. No.: 17/569,481

(22) Filed: Jan. 5, 2022

(30) Foreign Application Priority Data
Aug. 2, 2021 (JP) 2021-126819

(51) Int. Cl. G06F 3/12

(52) U.S. Cl. CPC G06F 3/1204; G06F 3/1285; G06F 3/126

(57) ABSTRACT

An information processing device includes a processor configured to: transmit, to a local system, a printing screen transmission request including a list of printing devices usable by a user installed outside the local system; display a printing screen including a list of the printing devices and a list of files saved in the local system, the printing screen being received from the local system in response to the printing screen transmission request; and cause a printing device selected by the user from the printing screen to print a file selected by the user from the printing screen.

### CROSS-REFERENCE TO RELATED APPLICATIONS

This application is based on and claims priority under 35 USC 119 from Japanese Patent Application No. 2021-126819 filed Aug. 2, 2021.

### BACKGROUND

### (i) Technical Field

The present disclosure relates to an information processing device and method, a print system, and a non-transitory computer readable medium.

### (ii) Related Art

In recent years, the promotion of teleworking has led to more opportunities to work from home. In some cases, a worker working from home installs a printer purchased by the worker him- or herself or supplied by a company, and uses the printer to print documents at home. For example, see Japanese Unexamined Patent Application Publication No. 2014-089648.

### SUMMARY

For example, in the case where an on-demand print system is introduced into a local system inside a company, a certain document residing may be printed from within the local system from a printing device registered with the local system.

However, a printing device outside the local system, such as one at home for example, is ordinarily not registered with the local system, and consequently if an information processing device at home does not have an on-demand print function, a file saved in the local system may not be printed on a printing device at home outside the local system.

Aspects of non-limiting embodiments of the present disclosure relate to enabling an information processing device residing outside a local system to cause a printing device not registered with the local system to print a file saved in the local system, even if the information processing device lacks an on-demand print function.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to: transmit, to a local system, a printing screen transmission request including a list of printing devices usable by a user installed outside the local system; display a printing screen including a list of the printing devices and a list of files saved in the local system, the printing screen being received from the local system in response to the printing screen transmission request; and cause a printing device selected by the user from the printing screen to print a file selected by the user from the printing screen.

### BRIEF DESCRIPTION OF THE DRAWINGS

Exemplary embodiments of the present disclosure will be described in detail based on the following figures, wherein:

FIG. 1 is a block configuration diagram illustrating an exemplary embodiment of a print system according to the present disclosure;

FIG. 2A is a sequence diagram illustrating a process of causing a home printer to print a file saved in an on-demand print server in the exemplary embodiment;

FIG. 2B is a continuation of the sequence diagram illustrated in FIG. 2A;

FIG. 3 is a diagram illustrating an example of a printing screen displayed on a client terminal according to the exemplary embodiment;

FIG. 4 is a diagram illustrating an example of the display of the printing screen after a file is selected by a user according to the exemplary embodiment; and

FIG. 5 is a diagram illustrating an example of the display of the printing screen after a printer is selected by the user according to the exemplary embodiment.

### DETAILED DESCRIPTION

Hereinafter, a suitable exemplary embodiment of the present disclosure will be described on the basis of the drawings.

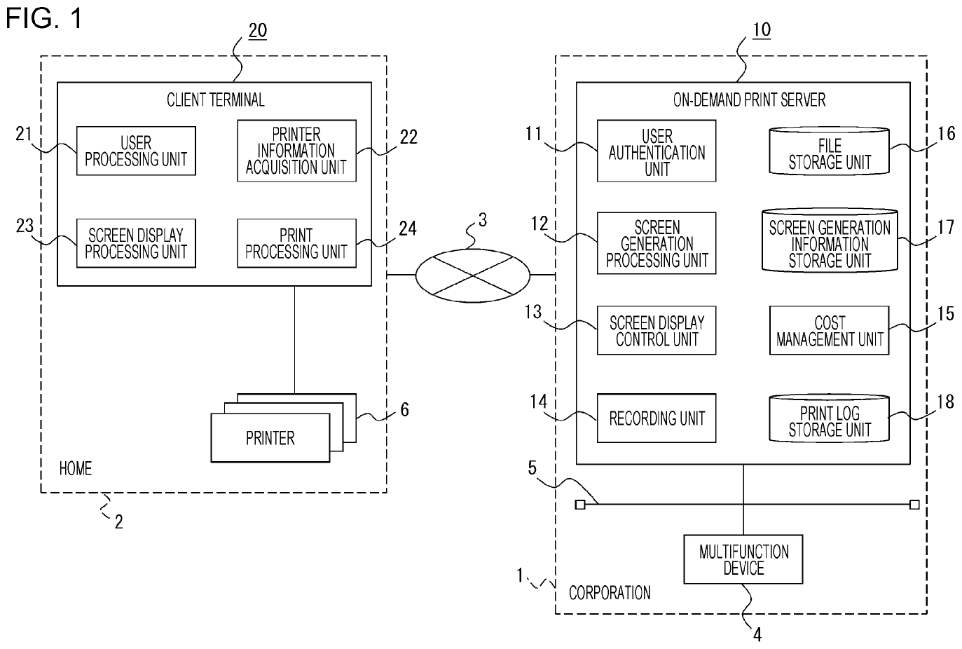

FIG. 1 is a block configuration diagram illustrating an exemplary embodiment of a print system according to the present disclosure. The print system is formed by connecting an on-demand print system set up inside a corporation 1 to a system installed in a home 2 of an employee of the corporation over a network 3 such as the Internet. The corporation 1 and the home 2 are connected by a virtual private network (VPN) for example, thereby allowing the secure exchange of data. Note that because any existing technology may be used to construct a secure network environment, in the exemplary embodiment, a description related to the network connection is omitted.

The on-demand print system of the corporation 1 is a local system set up by the corporation 1, and is set up by connecting an on-demand print server 10 and a multi-function device 4 by a local area network (LAN) 5. Note that the multi-function device 4 is an image generation device that supports on-demand printing. Although FIG. 1 illustrates only a single multi-function device 4, multiple multi-function devices 4 may also be connected.

The on-demand print server 10 may be achieved with a hardware configuration of an existing general-purpose server computer. In other words, the on-demand print server 10 includes a CPU that acts as a local processor, ROM, RAM, storage such as a hard disk drive, and a network interface provided as a communication medium.

The on-demand print server 10 includes a user authentication unit 11, a screen generation processing unit 12, a screen display control unit 13, a recording unit 14, a cost management unit 15, a file storage unit 16, a screen generation information storage unit 17, and a print log storage unit 18. Note that components not used in the description of the exemplary embodiment are omitted from illustration.

The user authentication unit 11 authenticates a user in response to a login request from the user. The “user” referred to in the exemplary embodiment is an employee of the corporation 1, for example. The user has an account (that is, a login ID and a password) for logging in to the on-demand print server 10. The screen generation processing unit 12 generates a printing screen to be displayed on a client terminal 20 used by the user in response to a screen transmission request from the user who uses the on-demand print server 10 by logging in from the home 2. The screen display control unit 13 controls the display of the printing screen displayed on the client terminal 20. The recording unit 14 acquires information related to an execution result of printing at the home 2, and registers the execution result in the print log storage unit 18 as a print log. Printing may be executed at the corporation 1 or at the home 2, but the costs associated with printing are thought to be different. The cost management unit 15 manages information related to the costs associated with printing, and in the case of the exemplary embodiment, manages information related to the costs associated with printing executed at the home 2 in particular.

The file storage unit 16 stores files such as documents to be printed by the on-demand print system of the corporation 1 and at the home 2, and also stores attribute information about the files. Note that the files to be printed may be stored in a shared repository in the on-demand print system or in a distributed manner on terminal devices or the like used individually by each user, but for convenience, the exemplary embodiment describes a case in which the files are saved in the file storage unit 16.

The screen generation information storage unit 17 stores information to be displayed on the printing screen. Print logs are accumulated in the print log storage unit 18.

Each of the components 11 to 15 in the on-demand print server 10 are achieved by cooperative action between the computer that forms the on-demand print server 10 and a program running on the CPU installed in the computer. Also, the storage units 16 to 18 are achieved by an HDD installed in the on-demand print server 10. Alternatively, RAM may be used, or a storage medium inside the on-demand print system may be used over the LAN 5.

The home 2 is an example of an environment outside the on-demand print system, and is a residence where a person such as an employee of the corporation 1 lives. The client terminal 20 and at least one printer 6 are installed in the home 2. The client terminal 20 corresponds to an information processing device according to the exemplary embodiment of the present disclosure, and is an information processing device used for teleworking from the home 2. The client terminal 20 may be a device such as a general-purpose personal computer (PC) including components such as a CPU, ROM, RAM, storage, a user interface, and a communication medium. The client terminal 20 is an example of an information processing device installed outside the on-demand print system, and does not have an on-demand print function.

As illustrated in FIG. 1, the client terminal 20 includes a user processing unit 21, a printer information acquisition unit 22, a screen display processing unit 23, and a print processing unit 24. Note that components not used in the description of the exemplary embodiment are omitted from illustration.

The user processing unit 21 performs a login process and a logout process with respect to the on-demand print server 10. The printer information acquisition unit 22 acquires information related to the printer 6 usable for printing by the client terminal 20. The screen display processing unit 23 requests the transmission of the printing screen. Additionally, the screen display processing unit 23 performs a setting process for printing according to a user operation performed on the printing screen transmitted and displayed in response to a transmission request. The setting process is performed in conjunction with the screen display control unit 13. The print processing unit 24 issues print instructions to the printer 6, acquires an execution result of the printing executed by the printer 6, and transmits the execution result to the on-demand print server 10 to report that printing has been executed at the home 2.

Each of the components 21 to 24 in the client terminal 20 are achieved by cooperative action between the computer that forms the client terminal 20 and a program running on the CPU installed in the computer.

The printer 6 is a printing device used at the home 2. In general, the printer 6 at the home 2 is not registered with the on-demand system of the corporation 1, and therefore is unavailable for use from within the corporation 1.

A program used in the exemplary embodiment obviously may be provided through a communication medium, and may also be provided by being stored on a computer-readable recording medium such as CD-ROM or USB memory. A program provided from a communication medium or a recording medium is installed onto a computer, and various processes are achieved by having the CPU of the computer sequentially execute the program.

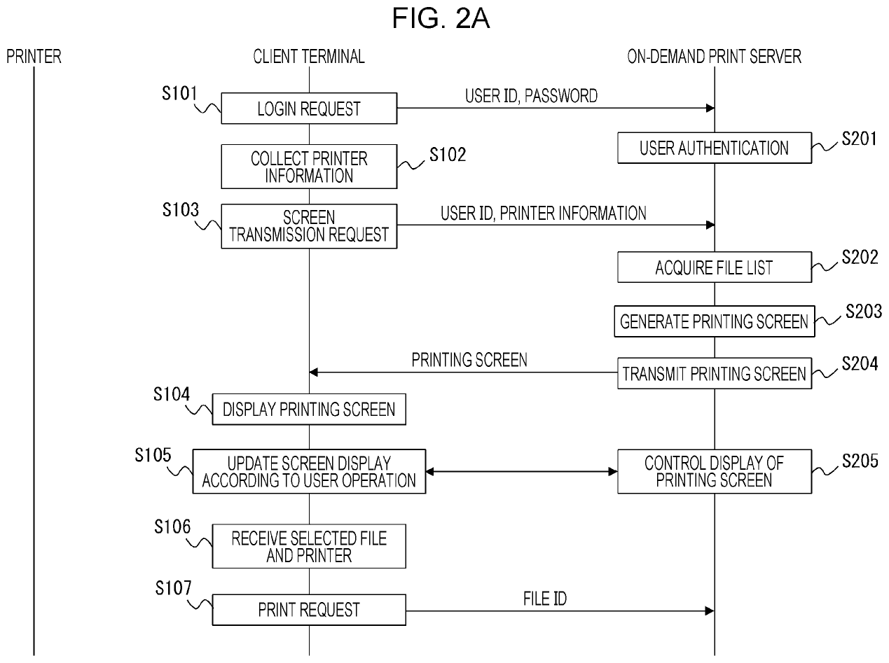

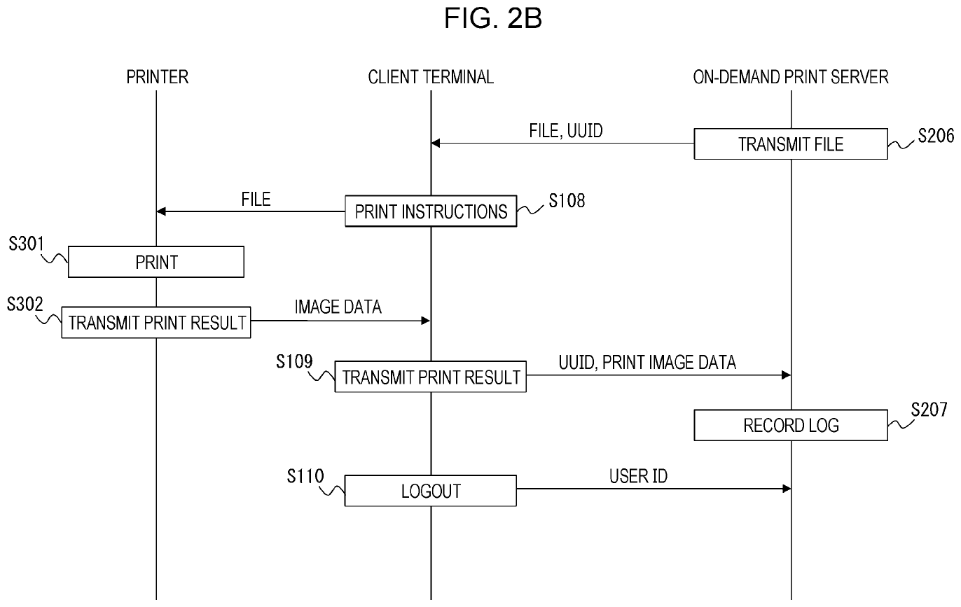

Next, operations according to the exemplary embodiment will be described. A feature of the exemplary embodiment is that when the user carries out duties at the home 2 using the client terminal 20 that does not have an on-demand print function, files saved in the on-demand print system are available for printing from the printer 6 in the home 2. Hereinafter, a process for causing a file saved in the on-demand print server 10 to be printed from the printer 6 in the home 2 will be described using the sequence diagrams illustrated in FIGS. 2A and 2B.

In the case where the user prints a file in the on-demand print system from the printer 6 in the home 2, first, the user specifies his or her own user ID and password as a login ID from a predetermined login screen. The user processing unit 21 acquires the user ID and the password inputted by the user, and issues a login request by transmitting the information to the on-demand print server 10 (step 101).

The user authentication unit 11 in the on-demand print server 10 performs user authentication on the basis of the transmitted information (step 201). At this point, the description will continue under the assumption that the user authentication is successful.

When the client terminal 20 logs in to the on-demand print server 10, next, the printer information acquisition unit 22 collects information related to the printer 6 that is connected to the client terminal 20 in a wired or wireless manner, and is therefore usable, as printer information (step 102). The content of the collected information includes information related to the specifications and basic functions of the printer 6, such as color, quality, simplex/duplex, paper size, and communication performance, and also information about optional functions such as a finisher, for example. Additionally, connection status information indicating the connection status between each printer 6 and the client terminal 20 is also included. In the case of a wireless connection, the connection status information includes at least one of the presence or absence of an encrypted communication function or a received signal strength of the printer 6, for example. The information may be collected from a printer driver, the communication medium, or the printer 6.

When the printer information acquisition unit 22 has collected the printer information, the screen display processing unit 23 transmits to the on-demand print server 10 a request to transmit a printing screen including the user ID of the user who is logged in to the client terminal 20, a list of usable printers 6, and printer information about each printer 6 (step 103). Note that the printer information to be transmitted may not be information corresponding to all printers 6 usable by the client terminal 20, but may be filtered to include only the printer(s) 6 specified in advance as a use candidate by the user.

The screen generation processing unit 12 receives the screen transmission request transmitted from the client terminal 20, and saves the acquired information in the screen generation information storage unit 17. Additionally, the user ID included in the screen transmission request is referenced to select files printable by the user. The files may be selected according to whether or not the owner of each file stored in the file storage unit 16 matches the transmitted user ID, for example. The screen generation processing unit 12 acquires a list of printable files from the selected files. The file list includes the file names as identification information about the selected files, and the screen generation processing unit 12 saves the list of file names in the screen generation information storage unit 17.

If a list of printable files is acquired successfully (step 202), the screen generation processing unit 12 generates a printing screen for the user by applying acquired item data to form data having a predetermined screen layout (step 203). The screen generation processing unit 12 uses a form that is the same or similar to a screen form provided by the on-demand print function as the form data of the screen. In other words, the on-demand print server 10 provides a printing screen to information processing devices such as PCs used inside the corporation 1, but the screen generation processing unit 12 generates a printing screen to be provided to the client terminal 20 in the home 2 in a format similar to the printing screen provided to the PCs inside the corporation 1. With this arrangement, the user is able to print by performing the same operations from printing screens having similar layouts both within the corporation 1 and at the home 2. Although the specific content of the printing screen generated by the screen generation processing unit 12 will be described later, the screen generation processing unit 12 transmits the generated printing screen to the client terminal 20 from which the screen transmission request originated (step 204).

When the printing screen is transmitted from the on-demand print server 10 in response to the screen transmission request, the screen display processing unit 23 causes the printing screen to be displayed (step 104). The printing screen may be created as a web page displayed by a browser. Here, the printing screen displayed on the client terminal 20 will be described.

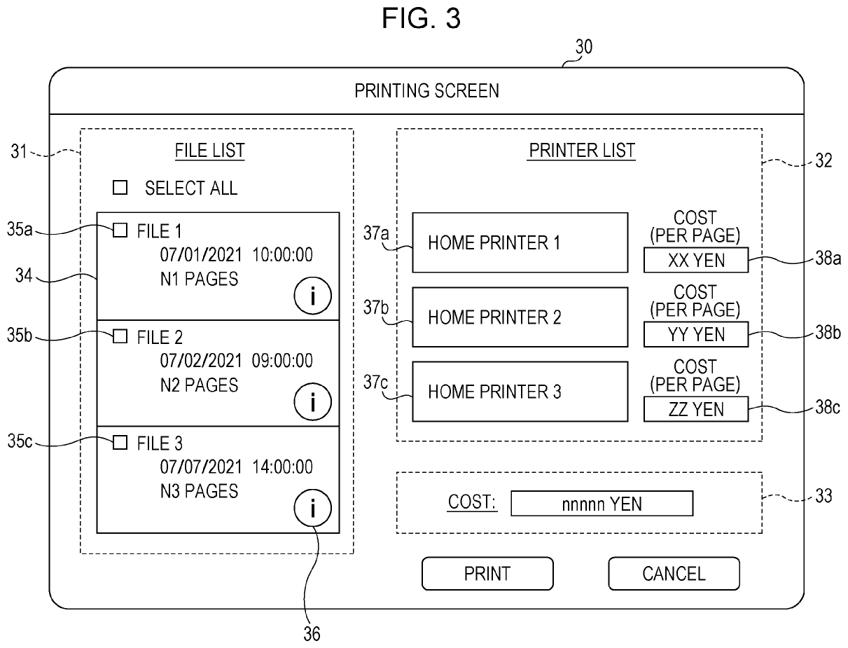

FIG. 3 is a diagram illustrating an example of a printing screen 30 displayed on the client terminal 20 according to the exemplary embodiment. The printing screen 30 is generated by the screen generation processing unit 12 of the on-demand print server 10 as described above by applying the printer information and the file list information acquired from the client terminal 20 and cost information acquired from the cost management unit 15 to a predetermined form screen.

As illustrated in FIG. 3, the printing screen 30 includes respective display regions 31 to 33 for a file list, a printer list, and a cost. In the file list display region 31, the list of files acquired in step 202, that is, a list of files treated as candidates for printing at the home 2, is displayed. Individual regions 34 for displaying information about each file are associated with each file. In each individual region 34, a checkbox 35 is associated with the file name of the file. The user selects a file to be printed by inputting a check into the checkbox 35. Note that the checkboxes 35a to 35c are collectively referred to as the “check box 35” as above when not being distinguished individually. The same applies to other display elements having the subscripts a to c appended to the reference sign. Additionally, an information button 36 is displayed in the individual regions 34. The information button 36 may be selected at any time. When the information button 36 is selected, attributes corresponding to the file are displayed. The user may use the attribute information displayed through the selection of the information button 36 as a reference for making a decision when selecting which file to be printed, for example. Also, although described in detail later, when an alert is displayed, the information button 36 may also be used to check the reason why the alert is displayed.

In the printer list display region 32, a list of the printers available for printing from the client terminal 20 from among the printers installed in the home 2, or in other words, the list of printers 6 that the client terminal 20 transmitted to the on-demand print server 10 in step 103, is displayed. Only one printer 6 is selectable at a time, and consequently the display region of the name of each printer acts as a printer selection button 37 that is selectable by the user. The user selects which printer 6 to be used for printing by selecting one of the printer selection buttons 37.

Note that the screen generation processing unit 12 may also perform a process of referencing the connection status information included in the printer information, treating a printer 6 whose received signal strength does not satisfy a predetermined threshold for example as a printer 6 that is unsuitable for printing a file, and not displaying the unsuitable printer 6 in the printer list display region 32. In other words, the screen generation processing unit 12 does not have to display the list of printers acquired from the client terminal 20 as-is, and may also filter the acquired printer list according to a predetermined basis to generate the printer list to be displayed in the printer list display region 32.

Also, in the printer list display region 32, a cost input region 38 is associated with each printer selection button 37. The user is able to set a printing cost in the cost input region 38. The exemplary embodiment illustrates an example in which the user is able to set the printing cost per page, but this cost setting is merely one example, and more detailed costs may be set according to other cost setting methods and properties such as the paper size and color printing. Note that when the printing screen 30 is displayed on the client terminal 20, an initial value calculated by the cost management unit 15 with reference to the functions, specifications, and the like of the printer 6 may be displayed in the cost input region 38.

In the cost display region 33, the cost incurred in the case of printing the file specified by the user from the printer 6 designated by the user is displayed. In other words, the cost is determined according to the combination of the file to be printed and the printer 6 to be used for printing the file. The user may use the displayed monetary amount as a reference for making the decision of whether to print.

The user selects the file to be printed and the printer 6 to be used for printing from the printing screen 30. Note that the display content of the printing screen 30 is updated according to user operations, but the display content is updated through coordinated operations by the screen display processing unit 23 of the client terminal 20 and the screen display control unit 13 of the on-demand print server 10.

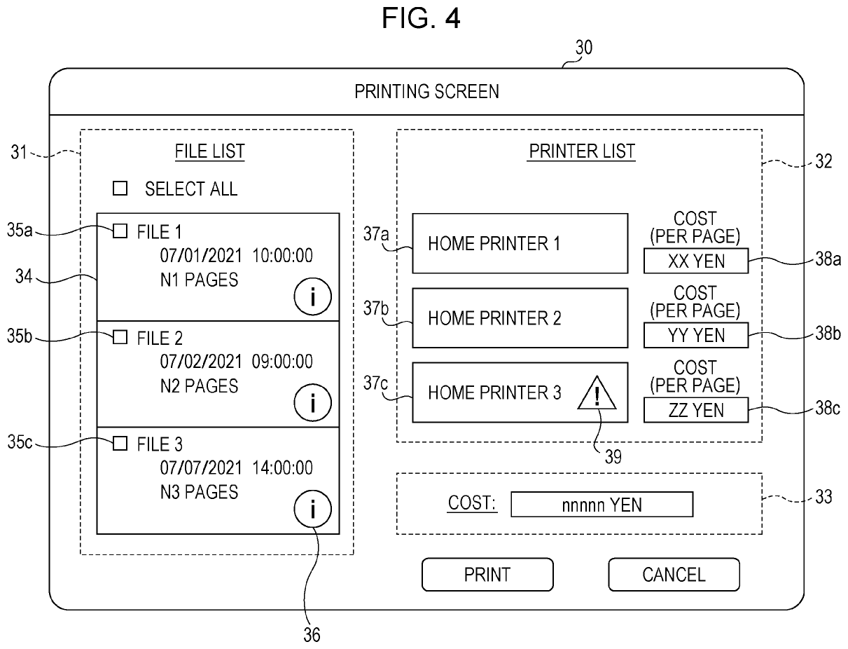

In the exemplary embodiment, either the file to be printed or the printer 6 to be used for printing may be selected first. Here, it is assumed that the user selects the desired file to be printed before selecting the printer 6 to be used for printing. For example, suppose that the user selects a File 1 by inputting a check into the checkbox 35a. In this case, the screen display processing unit 23 notifies the screen display control unit 13 that File 1 has been selected. In response to the notification, the screen display control unit 13 checks the attribute information of File 1. The file attribute information includes typical file attributes such as the name, owner, creation date and time, file size, number of pages, and file type of the file, and furthermore includes print attributes related to the content of settings for the file, such as the paper size and color set for the file, and optional functions such as a finisher to be used. The screen display control unit 13 compares the attribute information of File 1 selected by the user to the printer information of each printer 6 saved in the screen generation information storage unit 17, and thereby confirms whether or not File 1 is printable according to the print attributes set for File 1. An example of the display of the printing screen 30 indicating the confirmation result is illustrated in FIG. 4.

On the printing screen 30 illustrated in FIG. 4, “Home Printer 1”, “Home Printer 2”, and “Home Printer 3” are illustrated as the printers 6 available for printing by the user. Of these, a display element indicating an alert 39 is displayed inside the printer selection button 37c for “Home Printer 3”. Through the alert 39, the user is able to recognize that Home Printer 3 is unable to print File 1 according to the print attributes set for File 1. For example, in the case where a function is set with respect to File 1 for printing multiple pages included in File 1 on a single sheet of paper, also referred to by terms such as multiple pages per sheet or N-up printing, the alert 39 is displayed if Home Printer 3 does not have the function for printing multiple pages per sheet. Note that the user may also select the alert 39 to display the reason why printing according to the print attributes is unavailable. The user may refer to the display content on the printing screen 30 to select a print to be used for printing the file. Alternatively, the user may a select a different file if the user wants to print from Home Printer 3.

In the exemplary embodiment, the user is able to distinguish whether or not each printer 6 is capable of printing File 1 according to the print attributes set for File 1 according to whether or not the alert 39 is displayed in this way. Note that Home Printer 3 is simply unable to print File 1 according to the set print attributes, but is capable of printing itself, and therefore the user may select Home Printer 3 after acknowledging that Home Printer 3 does not support printing multiple pages per sheet.

Note that in the exemplary embodiment, the alert 39 is added to indicate whether or not printing according to the print attributes is possible, but the configuration is not limited to this example. For example, the printer selection button 37 corresponding to a printer 6 that is unable to print a file according to the print attributes may not be displayed in the printer list display region 32, thereby enabling the user to distinguish whether or not each printer 6 is capable of printing.

The display of the alert 39 is controlled in real time according to the selection of a file. Consequently, in the case where the user selects a different file other than File 1 as the file to be printed before confirming the execution of printing, there is a possibility that the display of the alert 39 may be changed according to the attribute information of the selected other file. Also, it is possible to select multiple files as the files to be printed, but the screen display control unit 13 may check the attribute information described above for each file selected by the user, and the screen display processing unit 23 may cause the alert 39 to be displayed depending on whether the multiple files are printable according to the print attributes. For example, suppose that the user selects File 2 and File 3. In this case, if Home Printer 2 is unable to print File 2 according to the print attributes, and Home Printer 2 and Home Printer 3 are unable to print File 3 according to the print attributes, the alert 39 is displayed in association with Home Printer 2 and Home Printer 3. Thereafter, if the user selects the alert 39 corresponding to Home Printer 2, the reason why File 2 is not printable according to the print attributes and the reason why File 3 is not printable according to the print attributes are displayed.

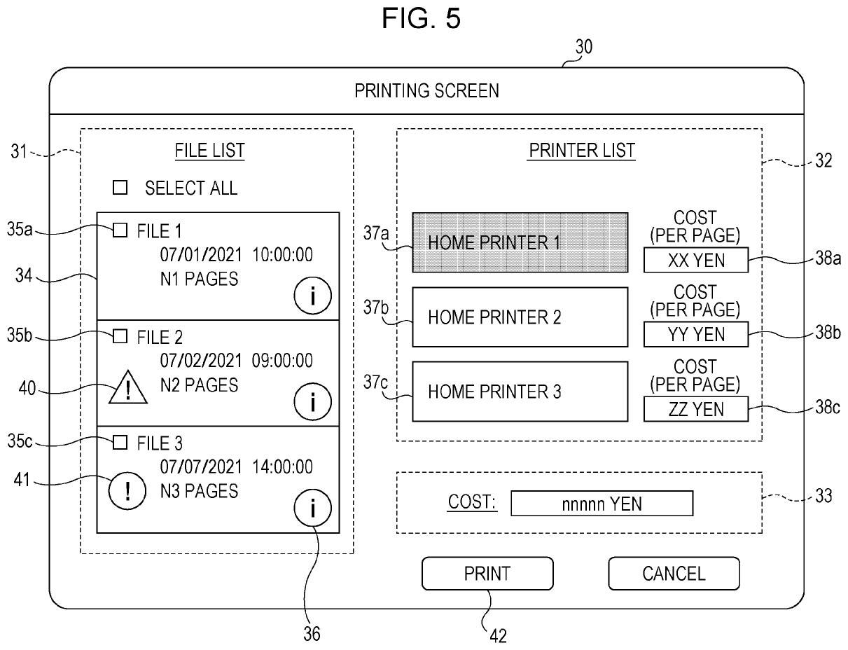

Next, suppose that the user selects the printer 6 to be used for printing before selecting the desired file to be printed. For example, suppose that the user selects the printer selection button 37a. In this case, the screen display processing unit 23 notifies the screen display control unit 13 that “Home Printer 1” has been selected. In response to the notification, the screen display control unit 13 reads out the printer information about Home Printer 1 from the screen generation information storage unit 17. Next, the screen display control unit 13 compares the read-out printer information of Home Printer 1 to the attribute information of each File 1 to 3 saved in the file storage unit 16, and thereby confirms whether or not each File 1 to 3 is printable according to the print attributes set for the file from Home Printer 1. An example of the display of the printing screen 30 indicating the confirmation result is illustrated in FIG. 5.

The printing screen 30 illustrated in FIG. 5 illustrates that Home Printer 1 is selected. Additionally, different types of alerts 40 and 41 are displayed in the individual regions 34 of Files 2 and 3. Through the alerts 40 and 41, the user is able to distinguish that File 1 is printable according to the print attributes from Home Printer 1, but Files 2 and 3 are not printable according to the print attributes from Home Printer 1. For example, the alert 40 is displayed because a color printing attribute is set for File 2 but Home Printer 1 does not have a color printing function. Also, the alert 41 indicating that File 3 is not printable is displayed because Home Printer 1 does not support the application or the version of the application that created File 3. Note that the alerts 40 and 41 may be selected to display the reasons why the alerts 40 and 41 are displayed, namely the reasons why the files are not printable according to the print attributes.

The user may refer to the display content on the printing screen 30 to select a file or select a different printer 6.

The display of the alerts 40 and 41 is controlled in real time according to the selection of the printer 6. Consequently, in the case where the user selects a different printer 6 to be used for printing before confirming the execution of printing, there is a possibility that the display of the alerts 40 and 41 may be changed according to the selected printer 6.

As described above, the user selects the file to be printed and the printer 6 to be used for printing from the printing screen 30. Additionally, the user changes the selection appropriately by referring to information such as the alerts 39 to 41 and the cost. The screen display processing unit 23 and the screen display control unit 13 cooperate to update the printing screen 30 appropriately according to the user operations (steps 105, 205). Also, the cost displayed in the cost display region 33 is updated each time according to the selected file and printer 6. Thereafter, if the user finally selects the file to be printed and the printer 6 to be used for printing and selects a print button 42 to give an instruction for printing, the screen display processing unit 23 accepts the selected file and printer 6 (step 106). Next, the print processing unit 24 issues a print request by transmitting the file ID of the accepted file to the on-demand print server 10 (step 107).

In response to the print request, the on-demand print server 10 acquires the file corresponding to the specified file ID from the file storage unit 16, and transmits the acquired file to the client terminal 20 (step 206). At this time, the on-demand print server 10 adds file identification information. Here, a universally unique identifier (UUID) may be generated as the file identification information, for example. The UUID also serves as identification information that uniquely specifies the print job. Adding the UUID to the file makes it possible to distinguish between print jobs even in the case where print jobs for the same file are executed by multiple client terminals 20 at the same time.

When the file is transmitted in response to the transmitted print request, the print processing unit 24 instructs the printer 6 selected by the user on the printing screen 30 to print the file (step 108).

The printer 6 executes printing according to the printing, and when printing is finished, the printer 6 transmits the printed image data, that is, an execution result including print image data, to the client terminal 20 (step 302). The print processing unit 24 acquires the print execution result from the printer 6, adds the UUID that was added to the printed file to the execution result, and transmits the print execution result with the added UUID to the on-demand print server 10 (step 109).

When the print execution result is transmitted from the client terminal 20, the recording unit 14 in the on-demand print server 10 records the execution result in the print log storage unit 18 as a print log (step 207).

If the corporation 1 is considered to be an on-premises environment, the home 2 corresponds to an external environment outside the on-premises environment. Generally, there is a higher probability of information leakage in an external environment compared to an on-premises environment. Consequently, in the exemplary embodiment, the print image data of the printed material is included in the print log for the printed material generated in the home 2 at least to enable easier tracking of leaked information in the hypothetical case where information leakage occurs.

Note that in the above exemplary embodiment, the printer 6 generates the print image data, but the client terminal 20 may also generate the print image data from the transmitted file, or the on-demand print server 10 may generate the print image data from the print result and the file associated with the UUID.

When the printing of a file in the home 2 as described above is finished, the user gives an instruction to log out from a predetermined logout screen. The user processing unit 21 logs out from the on-demand print server 10 according to the instruction from the user (step 110).

Note that although the exemplary embodiment describes an example in which the on-demand print system is treated as a local system and the home 2 is treated as an environment outside the local system, the above is merely an example. For instance, an environment such as a coworking space or a system of another corporation may also be treated as the environment outside the local system.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device comprising:
a processor configured to:
transmit, to a local system, a printing screen transmission request including a list of printing devices usable by a user installed outside the local system;
display a printing screen including a list of the printing devices and a list of files saved in the local system, the printing screen being received from the local system in response to the printing screen transmission request; and
cause a printing device selected by the user from the printing screen to print a file selected by the user from the printing screen.

2. The information processing device according to claim 1, wherein:
the processor is configured to:
acquire, from the local system, a file to be printed by the printing device and identification information of the file; and
acquire an execution result of printing the file by the printing device, add the identification information to the execution result, and transmit the execution result to the local system.

3. The information processing device according to claim 2, wherein:
the execution result includes print image data of the file.

4. The information processing device according to claim 1, wherein:
when a file to be treated as a print candidate is selected by the user from the printing screen, the processor is configured to display information enabling the user to distinguish a printing device capable of printing the file from among the list of printing devices.

5. The information processing device according to claim 1, wherein:
when a printing device to be used to execute printing is selected by the user from among the list of printing devices, the processor is configured to display information enabling the user to distinguish whether or not a file included in the list of files is printable by the selected printing device.

6. The information processing device according to claim 1, wherein:
the process is configured to display information further enabling the user to distinguish whether or not a file printable by the selected printing device is printable according to print attributes set for the file.

7. The information processing device according to claim 1, wherein:
the printing screen includes a cost incurred in a case where the user executes printing outside the local system.

8. The information processing device according to claim 7, wherein:
the cost is determined according to a combination of the printing device to be used to execute printing and the file to be printed.

9. A print system comprising:
the information processing device according to claim 1;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

10. A print system comprising:
information processing device according to claim 2;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

11. A print system comprising:
information processing device according to claim 3;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

12. A print system comprising:
information processing device according to claim 4;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

13. A print system comprising:
information processing device according to claim 5;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

14. A print system comprising:
information processing device according to claim 6;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

15. A print system comprising:
information processing device according to claim 7;
a local processor installed in the local system; and
a printing device usable by the user of the information processing device, wherein:
the local processor is configured to:
generate a printing screen including a list of printing devices and a list of files printable by the user in response to a printing screen transmission request including a list of printing devices usable by the user outside the local system, the printing screen transmission request being transmitted from the information processing device;
transmit the generated printing screen to the information processing device; and
in response to a print request from the information processing device, transmit a file designated by the print request together with identification information of the file to the information processing device.

16. The print system according to claim 9, wherein:
the local processor is configured to generate a printing screen to be transmitted to the information processing device in a format similar to a printing screen provided to an information processing device connected to the local system.

17. The print system according to claim 16, wherein:
the printing screen transmission request includes connection status information indicating a status of a connection with the information processing device for each printing device, and
the local processor is configured to reference the connection status information to generate the list of printing devices included on the printing screen.

18. The print system according to claim 17, wherein:
in a case of wireless communication, the connection status information includes at least one of a presence or absence of encrypted communication or a communication strength.

19. An information processing method comprising:
transmitting, to a local system, a printing screen transmission request including a list of printing devices usable by a user installed outside the local system;
displaying a printing screen including a list of the printing devices and a list of files saved in the local system, the printing screen being received from the local system in response to the printing screen transmission request; and
causing a printing device selected by the user from the printing screen to print a file selected by the user from the printing screen.

20. A non-transitory computer readable medium storing a program causing a computer to execute a process comprising:
transmitting, to a local system, a printing screen transmission request including a list of printing devices usable by a user installed outside the local system;
displaying a printing screen including a list of the printing devices and a list of files saved in the local system, the printing screen being received from the local system in response to the printing screen transmission request; and
causing a printing device selected by the user from the printing screen to print a file selected by the user from the printing screen.
